(19) United States
(12) Patent Application Publication
(10) Pub. No.: US 2024/0182203 A1
(43) Pub. Date: Jun. 6, 2024

(54) PERSONAL CARE PRODUCT TRAY

(71) Applicant: The Gillette Company LLC, Boston, MA (US)

(72) Inventors: Jeffrey Richard Holley, Scituate, MA (US); Jiong Hui Li, Braintree, MA (US); Kelvin Nguyen, Quincy, MA (US); Richard Kevin Sennett, Abington, MA (US)

(21) Appl. No.: 18/074,119

(22) Filed: Dec. 2, 2022

(51) Int. Cl. B65D 5/50; B65D 5/20; B65D 81/133

(52) U.S. Cl. CPC B65D 5/5038; B65D 5/20; B65D 81/133

(57) ABSTRACT

A tray with a first lateral panel having an unfolded position and a folded position. The first lateral panel has a top surface defining a first recess and a bottom surface. A second lateral panel has an unfolded position and a folded position. The second lateral panel has a top surface defining a second recess and a bottom surface. A center panel is positioned between the first panel and the second panel. The center panel has a top surface defining a cavity configured to receive one or more personal care products. A first fold line is located between the first lateral panel and the center panel. A second fold line is located between the second lateral panel and the center panel. The bottom surfaces of the first and second panels face each other in the folded position and do not face each other in the unfolded position.

### FIELD OF THE INVENTION

The present invention relates generally to packages for personal care products and more particularly, to packaging trays for shaving razors.

### BACKGROUND OF THE INVENTION

Blister-type packages are popular for storing and displaying articles for sale. The two primary components of a blister pack are the cavity or pocket made from a formable material, (e.g., plastic) and a lid (e.g., paperboard or plastic). The formed cavity or pocket contains the product and the lid seals the product within the cavity. Other types of blister packs may consist of clamshell packages where the products are contained between two clear pre-formed plastic blisters (e.g., polyethylene terephthalate or polyvinylchloride). The consumer can easily examine the product through the transparent plastic. The plastic shell is vacuum-formed around a mold so it can contain the item snugly. The card may be brightly colored and designed depending on the item inside, and the pre-formed plastic is affixed to the card using heat and pressure to activate an adhesive (heat seal coating) on the blister card. The adhesive is strong enough so that the pack may survive shipment and hang on a peg, but weak enough so that the package can be easily opened. The card may also have a perforated window for access. A more secure package is known as a clamshell. It is often used to deter package pilferage for small high-value items such as consumer electronics. It consists of either two pre-formed plastic sheets or one sheet folded over onto itself and fused at the edges. They are usually designed to be difficult to open by hand so as to deter tampering. A pair of scissors or a sharp knife is often required to open them. Care must be used to safely open some of these packages.

Blister packs are typically thermoformed. Thermoforming is a manufacturing process where a plastic sheet is heated to a pliable forming temperature, formed to a specific shape in a mold, and trimmed to create a usable product. The sheet (or film when referring to thinner gauges and certain material types), is heated in an oven to a high-enough temperature that it can be stretched into or onto a mold and cooled to a finished shape. For high-volume applications, very large production machines are utilized to heat and form the plastic sheet and trim the formed parts from the sheet in a continuous high-speed process, and can produce many thousands of finished parts per hour depending on the machine and mold size and the size of the parts being formed.

Consumers have been demanding environmentally friendly changes in consumer product packaging, such as minimizing the use of plastic and other nonrenewable materials. Many consumers are concerned about the environmental impact of packaging. Researchers believe that global green initiatives have strongly influenced this consumer attitude. Researchers also believe this new consumer attitude that will continue to push packaging manufacturers into finding environmentally friendly packaging alternatives. Typical plastics take an extended period of time to compost (break down) in a landfills. New environmentally friendly packaging materials are made from renewable materials that can be grown quickly (unlike most trees). Renewable materials may be recyclable and/or biodegradable. Several alternatives to plastics have been developed for thermoforming blister packs and trays, such as, renewable paper board and plant fiber(s). Despite the environmental advantages of these materials, current manufacturing processes (e.g., thermoforming) often limit the design and functionality of the final package. For example, the blister pack may require multiple angled sides because of draft angle requirements in order to remove the pack from a mold or tool during manufacturing. Due to material and manufacturing limitations, the formed packages may not have the same rigidity as their plastic counterparts. Accordingly, sustainable packages often require designs that use more material, which is not beneficial from a cost or sustainability perspective.

Despite the use of known packaging techniques, there remains a need to further modify personal care packages to provide a tray that is sustainable and also conveniently and efficiently retains and displays personal care items in a manner that is intuitive and easy to use for a consumer.

### SUMMARY OF THE INVENTION

In one aspect, the invention features, in general a tray with a first lateral panel having an unfolded position and a folded position. The first lateral panel has a top surface defining a first recess and a bottom surface. A second lateral panel has an unfolded position and a folded position. The second lateral panel has a top surface defining a second recess and a bottom surface. A center panel is positioned between the first panel and the second panel. The center panel has a top surface defining a cavity configured to receive one or more personal care products. A first fold line is located between the first lateral panel and the center panel. A second fold line is located between the second lateral panel and the center panel. The bottom surfaces of the first and second panels face each other in the folded position and do not face each other in the unfolded position.

In another aspect, the invention features, in general, a method of manufacturing a tray by forming a first panel, a second panel and a center panel from a sustainable material. A first fold line is formed between the first panel and the center panel. A second fold line is formed between the second panel and the center panel. A first recess is formed into a top surface of the first panel.

A second recess is formed into a top surface of the second panel. A cavity is formed into a top surface of the center panel which is configured to receive one or more personal care products. The first panel is folded along the first fold line. The second panel is folded along the second fold line. A bottom surface of the first lateral panel engages an outer surface of the cavity. A bottom surface of the second lateral panel engages the outer surface of the cavity.

### BRIEF DESCRIPTION OF THE DRAWINGS

FIG. 1 is a perspective assembly view of one possible embodiment of a personal care product package with a tray in a folded position.

FIG. 2 is a top perspective view of the tray in an unfolded position.

FIG. 3 is a bottom perspective view of the tray in the unfolded position.

FIG. 4 is a front view of the tray in the folded position.

FIG. 5 is a bottom perspective view of the tray in the folded position.

### DETAILED DESCRIPTION OF THE INVENTION

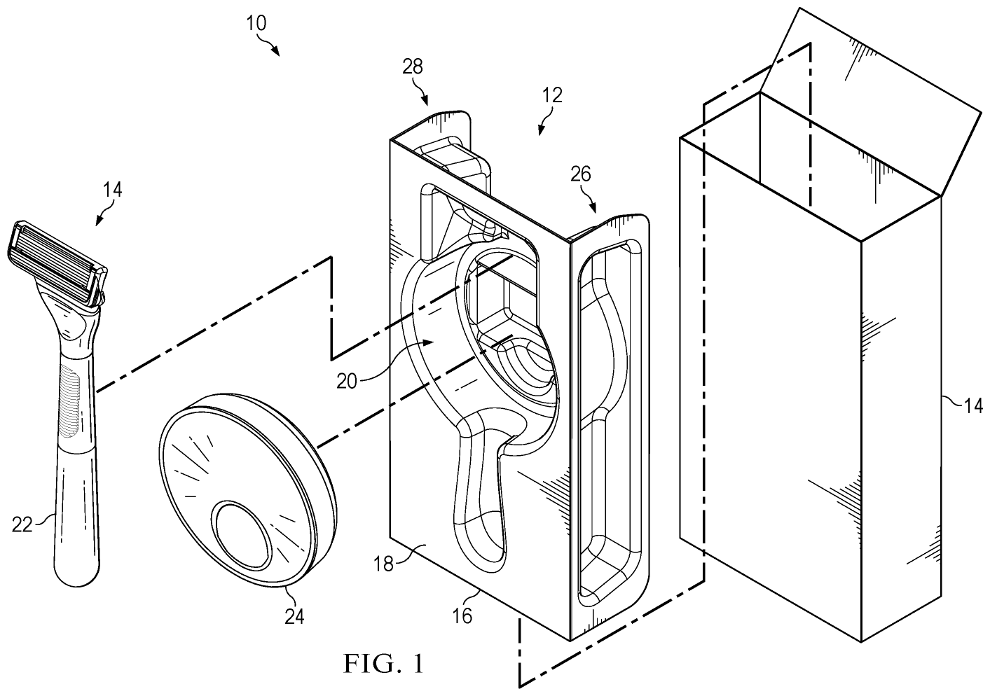

Referring to FIG. 1, a perspective view of one possible embodiment of a personal care product package 10 for a personal care product is illustrated. The personal care product package 10 may include a tray 12 in a folded position that may be contained within a box 14. However, it is understood the tray 12 may be utilized without the box 14. Although the box 14 is illustrated as being generally rectangular, it is understood the box 14 may be any shape to retain and prevent the folded tray 12 from unfolding. The tray 12 may include a center panel 16 having a top surface 18 defining a cavity 20 configured to hold one or more personal care products, such as a shaving razor 22 and a shaving razor stand 24. However, the tray 12 may include any number of personal care items such as, powered and manual toothbrushes, toothbrush stands and other toiletry products. As will be described in greater detail below, the tray 12 may include a first lateral panel 26 and a second lateral panel 28 that may be folded to support the center panel 16. FIG. 1 illustrates the first lateral panel 26 and a second lateral panel 28 both in a folded position. The folded position may be the final assembled position of the tray 12.

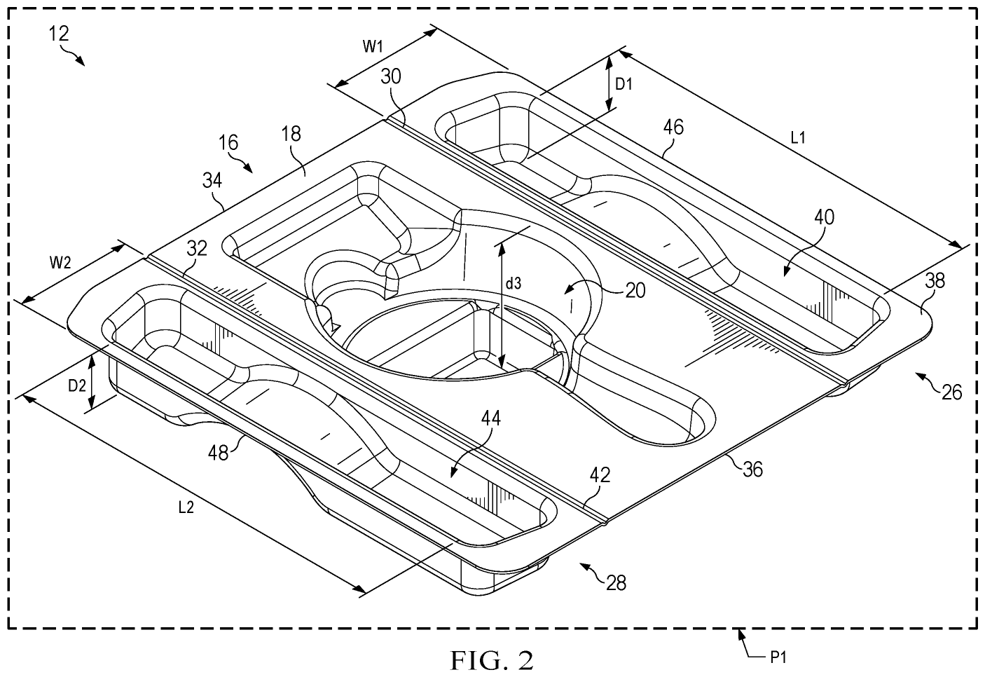

Referring to FIG. 2, a top perspective view of the tray 12 is illustrated with the first lateral panel 26 and the second lateral panel 28 both in an unfolded position. For example, the tray 12 may be formed from a sheet of sustainable material that is folded during a secondary process. The tray 12 may comprise one or more cellulose-based products such as cardboard, paperboard, paper sheet, bamboo and other sustainable, compostable, biodegradable or recycled/recyclable materials. The tray 12 may also be made from a slurry of water and pulp from fibrous materials, such as wood pulp or recycled paper products, or other natural fibers (e.g., sugarcane, bamboo, wheat straw). The raw materials may help determine the color, surface texture and strength of the tray 12. The pulp may be formed into a shape by custom designed molds. The molds are lowered into a pulp mixture and water is pulled through a mesh of the mold with a vacuum. An upper part of the mold may press into the lower part of the mold to arrive at the final shape. The tray 12 may be formed with numerous other processes, such as drawing, folding, stamping, molding, thermoforming, 3D printing, dry forming and wet forming.

The tray 12 may have a first fold line 30 and a second fold line 32 to facilitate the folding of the first lateral panel 26 and the second lateral panel 28. The first fold line 30 may be positioned between the center panel 16 and the first lateral panel 26. The second fold line may be positioned between the center panel 16 and the second side lateral panel 28. Accordingly, the center panel 16 may be positioned between the first lateral panel 26 and the second lateral panel 28. When forming and folding a sheet of material, the folding steps may be facilitated by providing fold lines such as, crease lines, cut lines, perforations, partial cuts, slit scores, pre-break, or a combination of these. The term fold line is used herein is understood as a general description of any of these techniques which may be used to facilitate accurate folding along a predetermined path. The tray 12 may have a nominal wall thickness of about 0.5 mm to about 1.5 mm and preferably about 0.8 mm to about 1.2 mm, as determined from the sheet of material used to form the tray 12. The first fold line 30 and the second fold line 32 may extend from a forward edge 34 of the tray 12 to a rearward edge 36 of the tray 12. In certain embodiments, the first fold line 30 and the second fold line 32 may extend continuously from the forward edge 34 to the rearward edge 36 to facilitate proper folding of the tray 12. The first fold line 30 and the second fold line 32 may extend about 40% to about 60% into the thickness of the tray 12 to facilitate folding of the first lateral panel 26 and the second lateral panel 28. For example, the fold line 32 may have a depth of about 0.3 mm to about 0.5 mm.

The first lateral panel 26 may have a top surface 38 that defines a first recess 40. Similarly, the second lateral panel 28 may have a top surface 42 that defines a second recess 44. The first recess 40 and the second recess 44 may have a respective depth “d1” and “d2” of about 5 mm to about 25 mm and preferably about 10 mm to about 20 mm. The depth of the first recess 40 and the second recess 44 may vary along their respective lengths. Accordingly the depth “d1” and “d2” may represent the deepest portion of the first recess 40 and the second recess 44, respectively. The first recess 40 and the second recess 44 may provide improved structural rigidity of the tray 12 when they are in the folded position. The first recess of 40 of the top surface 38 of the first lateral panel 26 may have a length L1 of about 100 mm to about 200 mm and more preferably about 125 mm to about 175 mm. Similarly, the second recess 44 of the top surface 42 of the second lateral panel 28 may have a length L2 of about 100 mm to about 200 mm and more preferably about 125 mm to about 175 mm.

In certain embodiments, the cavity 20 of the center panel 16 may have a depth “d3” that is greater than “d1” and “d2”. In certain embodiments, the depth “d3” may be about 25 mm to about 50 mm. The first lateral panel 26 may have a width “w1” extending from the first fold line 30 to a first lateral edge 46 of about 20 mm to about 30 mm. The first recess 40 may not extend all the way to the first lateral edge 46. The second lateral panel 28 may have a width “w2” extending from the second fold line 32 to a second lateral edge 48 of about 20 mm to about 30 mm. The second recess 44 may not extend all the way to the second lateral edge 48. In certain embodiments, the width “w1” of the first lateral panel 26 and the width “w2” of the second lateral panel 28 may be greater than the depth “d3” of the center panel 16. Accordingly, the tray 12 may securely rest on the first and second lateral edges 46 and 48 when put inside the box 14 or when placed on a counter or shelf. In the unfolded position the top surface 38 of the first lateral panel 26 and the top surface 42 of the second lateral panel 28 may face in the same direction as the top surface 18 of the center panel 16. For example, the top surface 38 of the first lateral panel 26, the top surface 42 of the second lateral panel 28 and the top surface 18 of the center panel 16 may be positioned on a common plane P1 in the unfolded position. In the folded position, the top surface 38 of the first lateral panel 26 and the top surface 42 of the second lateral panel 28 may be positioned below the top surface of 18 of the center panel.

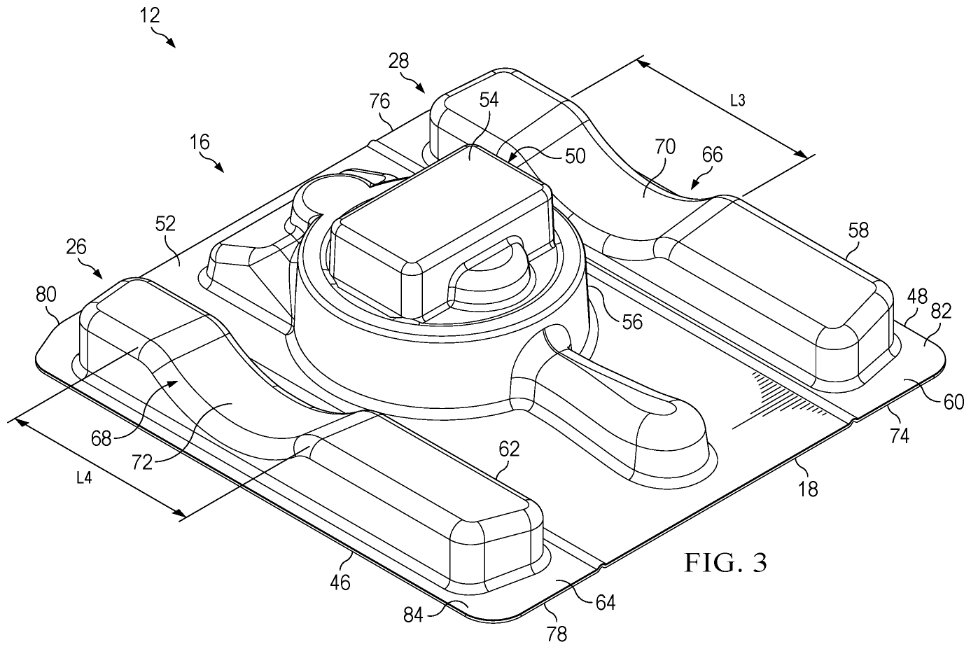

Referring to FIG. 3, a bottom perspective view of the tray 12 in the unfolded position. The forming of the cavity 20 in the top surface 18 of the center panel 16 (see FIG. 2) may create a corresponding protrusion 50 on a bottom surface 52 of the center panel 16. The protrusion 50 may have a lower surface 54 and an outer side surface 56. In certain embodiments, the outer side surface 56 may be curved, for example, convex. The outer side surface 56 may have a radius of about 20 mm to about 50 mm and more preferably about 30 mm to about 40 mm. The forming of the first recess 40 of the top surface 38 of the first lateral panel 26 (see FIG. 2) may create a corresponding protrusion 58 in a bottom surface 60 of the first lateral panel 26. The forming of the second recess 44 of the top surface 42 of the second lateral panel 28 (see FIG. 2) may create a corresponding protrusion 62 in a bottom surface 64 of the second lateral panel 28. As will be described in greater detail below, a portion 66 of the protrusion 58 and a portion 68 of the protrusion 62 may face and/or engage the outer side surface 56 of the protrusion 50 of the center panel 16. Accordingly, the portion 66 and the portion 68 may be complementary to the outer side surface 56. For example, the portion 66 may include a curved surface 70 (e.g., concave) that face and/or engages the outer side surface 56 having a corresponding convex geometry. Similarly, the portion 68 may include a curved surface 72 (e.g., concave) that face and/or engages the outer side surface 56 having a corresponding convex geometry. The curved surfaces 70 and 72 may have a radius of about of about 20 mm to about 50 mm and more preferably about 30 mm to about 40 mm to match the radius of the outer side surface 56. As shown in FIG. 3, the bottom surface 60 of the first lateral panel 26 (e.g., the curved surface 70) may not face the bottom surface 64 (e.g., the curved surface 72) of the second lateral panel 28, in the unfolded position. However, it is understood the portion 66 may include geometries other than curves that face and/or engage a geometry of the outer side surface 56.

In certain embodiments, a length L3 of the portion 66 may make up about 10% to about 100% of the length L1 of the first recess 40 and more preferably about 20% to about 70%. Similarly, a length L4 of the portion 68 may make up about 10% to about 100% of the length L2 of the second recess 44 and more preferably about 20% to about 70%. The protrusion 58 may not extend all the way to a forward edge 74, a rearward edge 76 and the first lateral edge 46 of the first lateral panel 26. The protrusion 62 may not extend all the way to a forward edge 78, a rearward edge 80 and the second lateral edge 48 of the second lateral panel 28. Accordingly, an outer flange 82 and 84 may be provided for the first lateral panel 26 and the second lateral panel 28, respectively. The outer flange 82 may extend around the protrusion 58 and the outer flange 84 may extend around the protrusion 62.

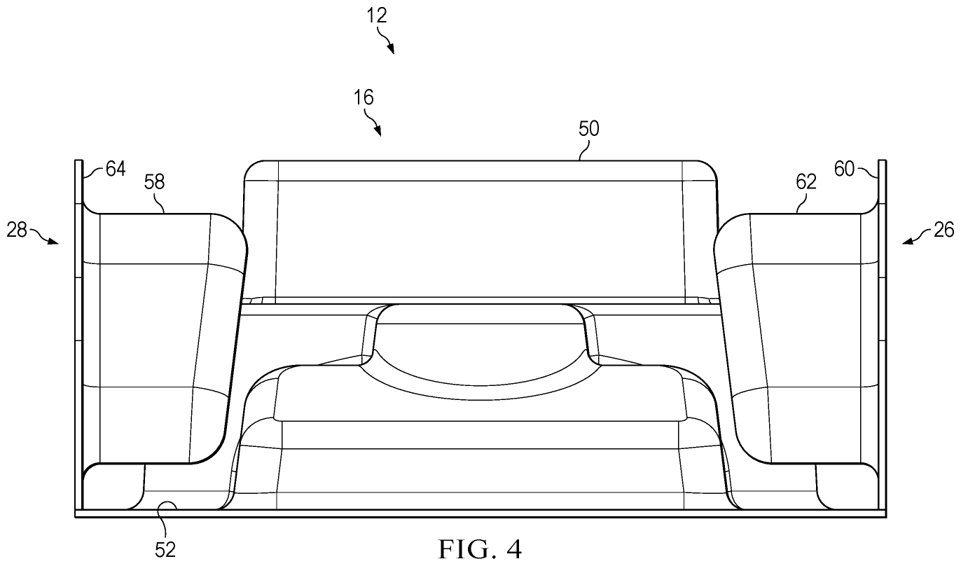

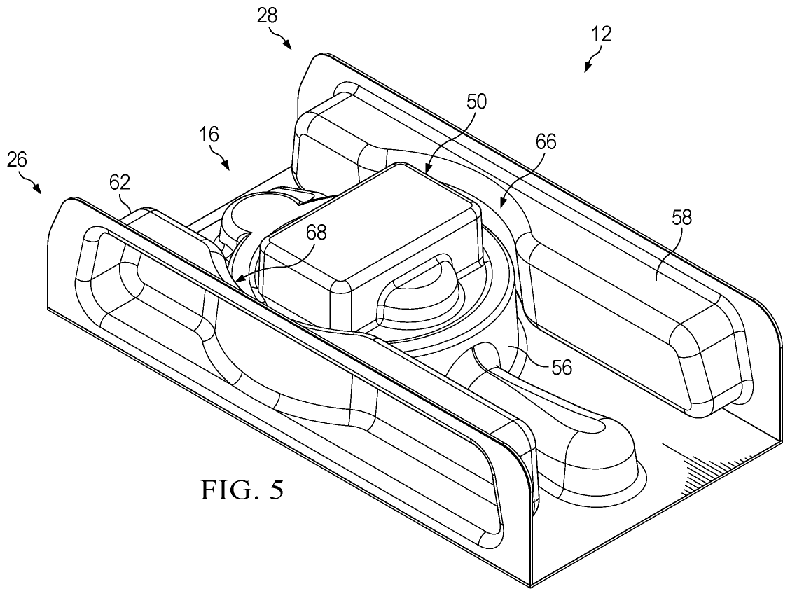

Referring to FIGS. 4 and 5, a front view and a bottom perspective view of the tray 12 are illustrated in the folded position, respectively. For example, the first lateral panel 26 may have a folded position and the second lateral panel 28 may have a folded position. In certain embodiments, the first lateral panel 26 and the second lateral panel 28 may each be folded approximately 90 degrees. For example, in the folded position, the first lateral panel 26 and the second lateral panel 28 may each be positioned 70 degrees to 110 degrees relative to the center panel 16. The protrusions 58 and 62 may be folded toward the protrusion 50 of the center panel 16, such that the bottom surface 60 of the first lateral panel 26 and the bottom surface 64 of the second lateral panel 28 face each other. In the folded position, the protrusion 58 of the first lateral panel 26 and the protrusion 62 of the second lateral panel 28 may both be spaced apart from the bottom surface 52 of the center panel 16, thus allowing sufficient clearance for the first lateral panel 26 and the second lateral panel 28 to be folded sufficiently (e.g., about 90 degrees). The bottom surface 60 of the first lateral panel 26 and the bottom surface 64 of the second lateral panel 28 may also face the protrusion 50 of the center panel 16. In certain embodiments, the bottom surface 60 of the first lateral panel 26 may be fixed to the outer side surface 56 of the cavity 20 (FIG. 3) and the bottom surface 64 of the second lateral panel 28 may be fixed to the outer side surface 56 of the cavity 20 (FIG. 3). For example, the portion 66 of the protrusion 58 and the portion 68 of the protrusion 62 may face and/or engage the outer side surface 56 of the protrusion 50 of the center panel 16, as shown in FIG. 5. In certain embodiments, the portion 66 of the protrusion 58 and the portion 68 of the protrusion 62 may be fixed to the protrusion 50 by press fitting, snap fitting or adhesive. However, it is understood that the portion 66 of the protrusion 58 and the portion 68 of the protrusion 62 may simply face and/or engage (e.g., contact) the outer side surface 56 of the protrusion 50 and the first lateral panel 26 and the second lateral panel 28 may stay in the folded position as it is positioned within the box 14 (FIG. 1).

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.” Furthermore, dimensions should not be held to an impossibly high standard of metaphysical identity that does not allow for discrepancies due to typical manufacturing tolerances. Therefore, the term “about” should be interpreted as being within typical manufacturing and measurement equipment tolerances.

Every document cited herein, including any cross referenced or related patent or application is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A personal care product tray comprising:
a first lateral panel having an unfolded position and a folded position, the first lateral panel having a top surface defining a first recess and a bottom surface;
a second lateral panel having an unfolded position and a folded position, the second lateral panel having a top surface defining a second recess and a bottom surface;
a center panel positioned between the first panel and the second panel, the center panel having a top surface defining a cavity configured to receive one or more personal care products;
a first fold line between the first lateral panel and the center panel;
a second fold line between the second lateral panel and the center panel, wherein the bottom surfaces of the first and second panels face each other in the folded position and do not face each other in the unfolded position.

2. The personal care product tray of claim 1 wherein the bottom surface of the first lateral panel and the bottom surface of the second panel both engage an outer surface of the cavity in the folded position.

3. The personal care product tray of claim 2 wherein the bottom surface of the first lateral panel and the bottom surface of the second panel each have a curved portion.

4. The personal care product tray of claim 3 wherein the curved portions of the bottom surfaces of the first lateral panel and the second lateral panel engage a curved portion of the outer surface of the cavity.

5. The personal care product tray of claim 1 wherein the bottom surface of the first lateral panel and the bottom surface of the second panel are spaced apart from a bottom surface of the center panel in the folded position.

6. The personal care product tray of claim 1 wherein the first lateral panel and the second lateral panel are positioned at an angle of about 70 degrees to about 110 degrees relative to the center panel in the folded position.

7. The personal care product tray of claim 6 wherein the top surface of the first lateral panel, the top surface of the second lateral panel and the top surface of the center panel are on a common plane in the unfolded position.

8. The personal care product tray of claim 1 wherein the package comprises one or more natural fiber pulps.

9. The personal care product tray of claim 1 wherein the recess of the first panel has a depth of 5 mm to 25 mm and the recess of the second panel has a depth of 5 mm to 25 mm.

10. The personal care product tray of claim 1 wherein a bottom surface of the first panel has a protrusion with a portion that engages an outer side surface of a protrusion of the center panel and a bottom surface of the second panel has a protrusion with a portion that engages the outer side surface of the protrusion of the center panel.

11. The personal care product tray of claim 10 wherein a length of the portion of the first panel is about 10% to 100% of a length of the recess of the first panel.

12. The personal care product tray of claim 1 further comprising a shaving razor positioned within the cavity.

13. A method of manufacturing a personal care product tray comprising:
forming a first panel, a second panel and a center panel from a sustainable material
forming a first fold line between the first panel and the center panel;
forming a second fold line between the second panel and the center panel;
forming a first recess into a top surface of the first panel;
forming a second recess into a top surface of the second panel;
forming a cavity into a top surface of the center panel configured to receive one or more personal care products;
folding the first panel along the first fold line;
folding the second panel along the second fold line;
facing a bottom surface of the first lateral panel towards an outer surface of the cavity; and
facing a bottom surface of the second lateral panel towards the outer surface of the cavity.

14. The method of claim 13 wherein the forming the first and second fold lines comprise one or more crease lines, cut lines, perforations, partial cuts, slit scores, pre-break or combinations thereof.

15. The method of claim 13 wherein the forming the first panel, the second panel and the center panel comprises dry pressing in a mold from an air-laid pulp web or wet pressing in a mold from a pulp slurry.

16. The method of claim 13 wherein the forming the cavity comprises forming a curved portion of the outer surface of the cavity.

17. The method of claim 16 wherein the forming first recess comprises forming a curved portion on the bottom surface of the first panel and the forming the second recess comprises forming a curved portion on the bottom surface of the second panel.

18. The method of claim 17 wherein the engaging the bottom surface of the first lateral panel with the outer surface of the cavity comprises engaging the curved portion of the bottom surface of the first panel with the curved portion of the outer surface of the cavity.

19. The method of claim 18 wherein the engaging the bottom surface of the second lateral panel with the outer surface of the cavity comprises engaging the curved portion of the bottom surface of the second panel with the curved portion of the outer surface of the cavity.

20. The method of claim 13 further comprising fixing the bottom surface of the first lateral panel to the outer side surface of the cavity and fixing the bottom surface of the second lateral panel with the outer surface of the cavity.
